(19) United States
(12) Patent Application Publication
(10) Pub. No.: US 2006/0186999 A1
(43) Pub. Date: Aug. 24, 2006

(54) Apparatus and method for reading/writing to RFID tags

(75) Inventor: Daniel McLaughlin, Homeworth, OH (US)

Correspondence Address: HAHN LOESER & PARKS, LLP, One GOJO Plaza, Suite 300, AKRON, OH, 44311-1076, US

(73) Assignee: CTM Integration, Inc.

(21) Appl. No.: 11/141,582

(22) Filed: May 31, 2005

Related U.S. Application Data
(60) Provisional application No. 60/654,724, filed on Feb. 18, 2005.

(51) Int. Cl. H04Q 5/22

(52) U.S. Cl. 340/10.51; 340/10.1

(57) ABSTRACT

An RFID system and method for performing read and write operations at different power levels. The system may include a reader and an antenna, the antenna being operably attached to the reader and wherein the reader through the antenna performs read operations at a first power level and write operations at a second power level.

This application claims priority from provisional application Ser. No. 60/654,724, filed Feb. 18, 2005, the disclosure of which is hereby incorporated by reference.

### FIELD OF THE INVENTION

The present invention relates to an apparatus and method for using a reader to perform read and write operations on a radio frequency identification (RFID) tag. More specifically, the apparatus and method relates to a reader that transmits RF signals (or waves) via an antenna at a first power level for read operations and a second power level for write operations on a radio frequency identification (RFID) tag.

### BACKGROUND OF THE INVENTION

Radio frequency identification (RFID) tags have recently become a preferred means of automatic identification as production costs have declined. RFID tags store user-defined information or data, and generally contain a microchip and an antenna. The microchips store information or data, while the antenna transmits and receives data via radio frequency (RF) waves. RFID tags may be passive, semi-active, or active, the designation being determined by the manner in which the device gets its power. Passive RFID tags do not contain an internal power source, and instead rely on RF (electromagnetic) waves sent by the reader (via an antenna) for power. Semi-active RFID tags contain a battery, whose only use is to power the microchip circuitry. The battery is not used to communicate with the reader. Active RFID tags are self-sufficient, being powered by an internal battery. Active tags provide a superior identification range and a larger capability set than passive or semi-active tags.

A reader may interrogate (i.e. power or activate) an RFID tag, receive data from a tag, or transmit data to a tag, the latter two equating to read and write operations, respectively. Readers accomplish this by transmitting RF waves via an antenna. The RF field generated by the antenna may also power a tag, such as a passive tag, as mentioned above. The RF power level directly affects the operating range of the reader and the quality of the operations. Further, the power level is directly affected by the operating conditions, such as, for example, the distance and angle between the reader and the target RFID tag, the type of tag, the manufacturer of the tag, and the surrounding structure, materials, and environment. Generally, the greater the power level, the greater the read/write range and quality. However, when operating at higher power levels, certain conditions may reduce read and/or write range and quality, such as, for example, when the reader is relatively close to an RFID tag or when the target RFID tag is relatively close to other tags. With the present movement by the FCC and other regulatory bodies to limit RF transmission power levels, these previously mentioned problems have become more real as, for example, RFID systems have reduced the transmission distance to compensate for a reduction in power. The diminished read and/or write performance results from, for example, RF reflections or undesired communications with non-targeted RFID tags, causing interference for the read and/or write operations. These problems can become magnified when performing both read and write operations because a single power level is commonly used to perform read and write operations. Consequently, corrective action has been required, which includes, for example, increasing the space between RFID tags, using insulating or non-reflective materials for surrounding structure, and strategically arranging the surrounding structure. Even though the corrective action positively affects the read/write operations, it adversely affects machine cycle times and costs. The present invention at least provides this novel solution to these problems.

### SUMMARY OF THE INVENTION

The present invention provides an apparatus and method relates to supplying to a reader elevated power when performing write operations, and reduced power when performing read operations, on a RFID tag, each as described in more detail below.

### BRIEF DESCRIPTION OF THE DRAWINGS

FIG. 1 is a diagram showing an RFID system of the present invention;

FIG. 2 is a chart showing a method of determining read and write RF transmission power levels for the RFID system shown in FIG. 1;

FIG. 3 is a side view of a label applicator in accordance with another embodiment of the present invention.

FIG. 4 is a top view of the label applicator shown in FIG. 3.

FIG. 5 is a side view of a snorkel unit in accordance with the another embodiment of the present invention.

FIG. 6 is a top view the snorkel unit shown in FIG. 5.

FIG. 7 is a front view of the snorkel unit shown in FIG. 5.

FIG. 8 is a side view of a label processing unit in accordance with another embodiment of the present invention.

FIG. 9 is a top view of the label processing unit shown in FIG. 8.

FIG. 10 is a side view showing the snorkel unit in operation.

FIG. 11 is a side view showing the snorkel unit ejecting a label.

FIG. 12 is a side view showing the snorkel unit transferring a label to the applicator unit.

FIG. 13 is a side view showing the snorkel unit and applicator unit in operation.

FIG. 14 is a chart showing a method of determining read and write RF transmission power levels for the RFID label applicator shown in FIG. 3.

### DETAILED DESCRIPTION OF THE PREFERRED EMBODIMENTS

An RFID system and method for performing read operations at a first power level and write operations at a second level on an RFID tag are disclosed herein. Prior art RFID systems perform read and write operations at the same power level. Yet, it is desirable to have different read and write transmission power levels, for example, when read operations are not possible at a required write power level, or vice versa. This may arise, for example, due to interference or reflective feedback caused by transmitting RF signals at a power level that is more than adequate to perform the desired task, such as, for example, when an RFID tag is located close to the antenna (such as, for example, approximately 0.02 to 1.5 inches), when RFID tags are located close to each other (which may activate or otherwise cause non-targeted tags to communicate with the reader), and when surrounding structure is close to the antenna. It is also desirable to have independent read and write transmission power levels to reduce energy consumption (i.e. to provide energy conservation).

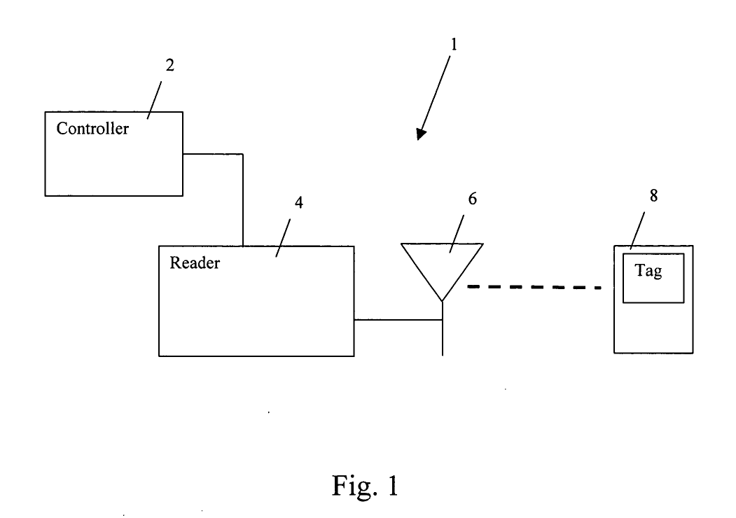

FIG. 1 discloses a basic RFID system 1 including a controller 2, a reader (or read/write unit) 4, and a reader antenna 6. It is contemplated that multiple controllers 2, readers 4, and/or antennas 6 may exist. Controller 2 may generally comprise, for example, a logic controller, an integrated circuit, a microprocessor, a computer, or any other commercially available controller that is capable of directing reader 4 to perform various operations, such as, for example, as instructed by a computer program. For example, controller 2 may specify certain data to be sent from reader 4 to an RFID tag 8, or determine when to perform a read or write operation. In the present embodiment, controller 2 may be designed via circuitry, programmed, or otherwise configured to direct (or instruct) reader 4 to transmit RF signals via antenna 6 at a first power level for read operations and a second power level for write operations. A program may automatically set the power levels (i.e. predetermined) or it may request the user to define the power levels, for example, through a user interface. It is contemplated that other means of controlling reader 4 may exist, such as by manually controlling the power or by providing a reader that is configured to transmit or otherwise direct an antenna to transmit RF signals at different power levels for read and write operations, such as, for example, via the reader's 4 circuitry. Therefore, the controller may exist, for example, as part of the reader 4 within its circuitry or it may exist independently of reader 4 as an internal component thereof or as an external unit.

Reader 4 may comprise any commercially available reader that is capable of performing read and write operations. It is contemplated that reader 4 may comprise separate units that independently perform the read and write operations, namely a read unit and a write unit, respectively. Reader 4 may support any protocol, such as, for example: EPC Classes 0, 0+, 1, 1 GEN 2; ISO 18000-6A; ISO 18000-6B; UCODE EPC 1.19; EM4022; EM4222; and EM4223. Reader antenna 6 may comprise any commercially known antenna as required by the specific circumstance, such as, for example, a dipole, loop, single-wire (or element), multi-wire (or element), coil, printed or deposited, sandwiched, or multi-polarized antenna. Although the present embodiment only contains a single antenna, multiple antennas may exist, for example, if multiple read and/or write areas exist or if reading and/or writing to multiple tags simultaneously. Reader 4 and antenna 6 may operate at any frequency, including those designated by the United States Federal Communications Commission (FCC) as low frequency—100-200 KHz, very high frequency (VHF)—13.56 MHz, ultra high frequency (UHF)—458-869-917 MHz, and microwave—2.45 GHz. Finally, although FIG. 1 depicts controller 2 and antenna 6 as being external of reader 4, it is contemplated that controller 2 and/or antenna 6 may be internal to reader 4.

Generally, for read operations reader 4 first transmits an RF signal through antenna 6 to activate or otherwise power RFID tag 8 at the direction of controller 2, the process often referred to as interrogation. Subsequently, tag 8 sends a responsive RF signal back to antenna 6, which is received by antenna 6. Consequently, reader 4 may translate the signals for external use or output, such as, for example, by or to a computer, a disk, etc. Note, the initial interrogation may not be necessary, for example, when the target RFID tag 8 is an active tag. Generally, for write operations, reader 4 generates a write signal at the direction of controller 2 and the antenna 6 transmits the signal to the RFID tag 8. After the write operation, the write operation may be verified by performing a subsequent read operation, as detailed above. In the present embodiment, controller 2 may dictate the power level at which the read signal and the write signal are transmitted from antenna 6.

RFID system 1, for example, may take the form of an RFID label applicator 10, thereby allowing read and write operations to be performed on RFID labels prior to or after their application to a target object since RFID labels include an RFID tag 8. As mentioned above among other options, controller 2 may include predetermined read and write power levels or the user may specify to controller 2 the desired read and write power levels. It is difficult to predetermine or preprogram these power levels since there are many variables that determine the amount of power necessary for read and write operations, including, for example, the system 1 design, the scenario and environment in which labels are applied, the type of RFID tag 8, the manufacturer of the RFID tag 8, and the transmission frequency. Therefore, it is often necessary to set-up the system 1 and determine acceptable read and write power levels.

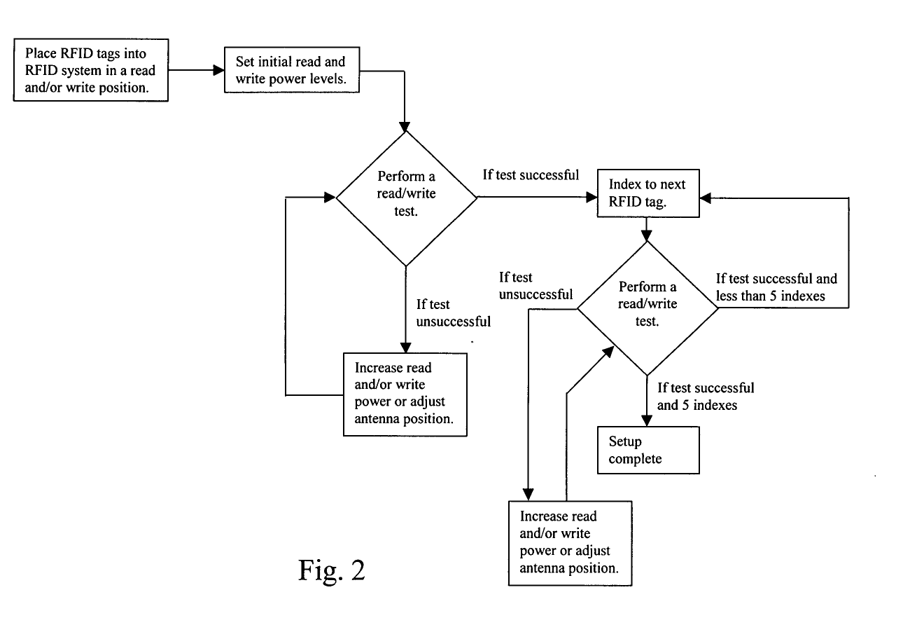

FIG. 2, as an example, shows a sample set-up routine that may be used to determine acceptable read and write power levels for a read and write operations. First, place tags 8 properly in the RFID system 1, such as, for example, an RFID label applicator 10. Depending on the system 1, it may be desirable to have the system 1 power off, such as for safety concerns. Ensure that tags 8 are properly positioned relative to antenna 8 as required by system 1, and, if necessary, make any necessary adjustments to tag 8 and/or antenna 6. The system 1 power may need to be turned on to ensure proper positioning of tag 8 within system 1. Second, turn the power on for the RFID system (if not already done) and set the initial read power and write power to an initial setting, such as, for example, 126 mW and 1120 mW, respectively. Generally, the initial read and write powers may comprise any power level; however, a more standard initial power level value for read and write operations for certain RFID system 1 configurations or requirements may be arrived at through simple trial and error, noting that different power levels may exist for different RFID system 1 configurations and requirements. Thirdly, perform a read/write test (or operation), such as, for example, performing a write and subsequent read or verification operation sequence ten (10) times. If the test is successful (meaning, for example, at least approximately 90% of the reads and approximately 90% of the writes were successful), index to the next tag 8 and perform a subsequent read/write test on the new tag. If the test on the new tag is successful, continue this process by indexing to the next tag and follow the previous steps until obtaining an acceptable series of consecutively successful read/write tests (such as, for example, a series of five (5) read/write tests); however, it is contemplated that a series of successful and unsuccessful tests may suffice in successfully setting up the system 1 if enough tests are run, such as, for example at least five (5) read/write tests. If a read/write test is unsuccessful (meaning, for example, less than approximately 90% of the reads or approximately 90% of the writes were successful) increase the read power if the reads are unsuccessful and/or increase the write power if the writes are unsuccessful (note that the write power may be similarly increased with the read power when obtaining unsuccessful reads in an effort to more efficiently obtain the acceptable write power setting). It is contemplated that if the success rate is below a certain number, such as, for example, 80%, the antenna may be adjusted without or in conjunction with making any power setting adjustments. After making any adjustments, perform a subsequent read/write test on the same tag. If the subsequent test is successful (meaning, for example, successfully completing at least approximately 90% reads and writes), follow the successful procedure detailed above. If the subsequent test is unsuccessful, (meaning, for example, successfully completing less than approximately 90% reads or writes), follow the unsuccessful procedure detailed above by making adjustments. It is contemplated that different system 1 configurations and requirements may require different success rates to define the successful and unsuccessful tests described above. Further, a higher rate of success may be required for the first successful read/write test, such as, for example 100%, while the remaining read/write tests may be successful at a lower success rate, such as, for example, 90%. It is also contemplated that the above detailed setup process, or any other setup process, may be used to reduce the read and write power levels in an effort to minimize or otherwise optimize the read and write power levels, such as, for example, when the initial power levels or any other power levels result in a successful read/write test, for which the read and write power levels would be reduced and a subsequent read/write test would be performed. Further, it is contemplated that system 1 may automatically adjust the read and/or write power during the normal operation of system 1 (i.e. in-line or after setup), which may include automatically adjusting the respective power levels (based on a calculation or by a predetermined increment) after a failed read and/or write operation and re-performing the read or write operation upon the same tag after making the adjustments. It is also contemplated that the above process may be used in a system 1 that has different read and write positions for tag 8 (as opposed to performing read and write operations on a single tag in a single tag location). Finally, instead of defining independent read and write power levels, a combined read/write power level may be defined along with a write boost power level to provide different read and write power levels.

As alluded to above, RFID system 1 designs are various and numerous. To better describe RFID system 1 and the principles discussed above, the following describes a sample RFID system 1. In this sample system, controller 2 is a controller that has digital and analog input and output, a group of serial port addresses, and its own operating system. In this example, controller 2 is a GE Fanuc IMC-7800773 independent motion controller. Reader 4, in this sample system, operates at ultra-high frequencies (UHF's) of 856-868 megahertz (MHz), 869.525 MHz, and 902-928 MHz and provides 4 watts (W) Effective Isotropic Radiated Power (EIRP) and 500 milliwatts (mW)/2 W Effective Radiated Power (ERP). Reader 4, in this sample system, also has digital inputs and outputs, communications ports, its own controller and operating system, and supports various protocols, including: EPC Classes 0, 0+, 1, and 1 GEN 2; ISO 18000-6A; ISO 18000-6B; UCODE EPC 1.19; EM4022; EM4222; and EM4223. In this example, reader 4 is a SAMsys MP9320 EPC reader. Antenna 6, in this sample system, is a UHF (865-928 MHz) linear dipole antenna. Antenna 6 may be purchased from SAMsys under model no. HI483-35-01. This sample also includes an acetal resin housing (see below discussion regarding label applicator 10) that surrounds and protects antenna 6, is approximately between 0.25 and 0.75 inches thick, and is located approximately between 0.01 and 0.5 inches from target tag 8, although these numbers, in part, depend on the tags used (their thicknesses), the thickness of the housing, and the material used for the housing. Target tag 8, in this sample system, is a common passive RFID tag, such as, for example, those manufactured by Alien, Rafsec, Texas Instruments, Matrix, or Avery. For this sample system, controller 2 is programmed to allow reader 4 to transmit RF signals from antenna 6 at power levels ranging between 32 mW, or 15 decibels relative to one milliwatt (dBm), and 1260 mW, or 31 dBm. In the end, for this sample system, successful read and write operations on the average passive RFID tag 8 generally occur at a read power (i.e. antenna's 6 read power) of approximately 126 mW (or 21 dBm) and a write power (i.e. antenna's 6 write power) of approximately 1120 mW (or 30 dBm). Still, depending on the setup of this sample system and the manufacturer of tag 8, read and write power can generally fall anywhere within the range of 32 mW to 1260 mW, except that the write power is different than the read power. Generally, the write power will be greater than the read power; however, it is contemplated that there may be scenarios where the read power may be greater than the write power, such as, for example, when reads are performed at greater distances than writes. It is important to note that this is one example or sample of RFID system 1, as contemplated by the present invention, since many variations and configurations exist, including, for example, operating at different frequencies, power levels, and distances between antenna 6 and the target RFID tag 8.

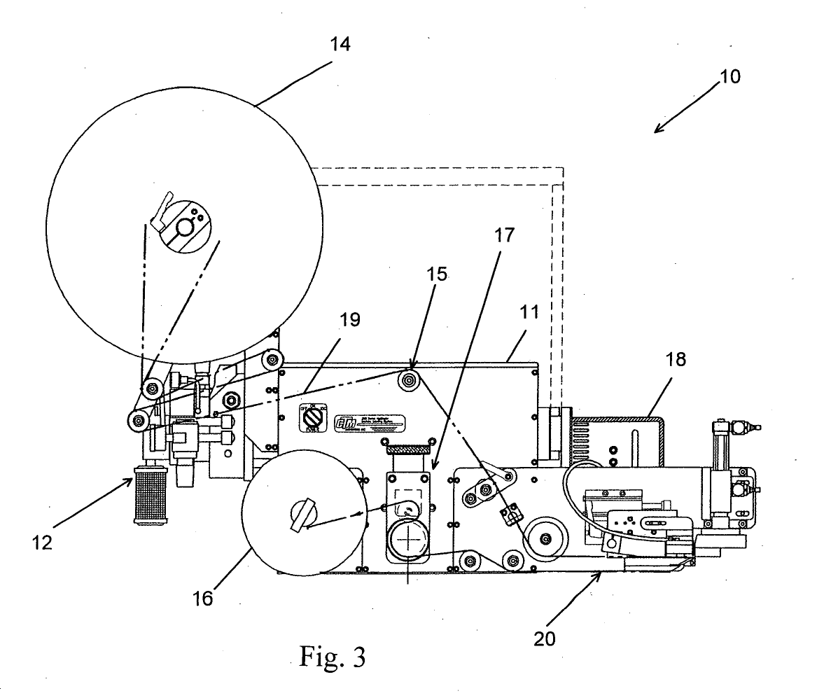

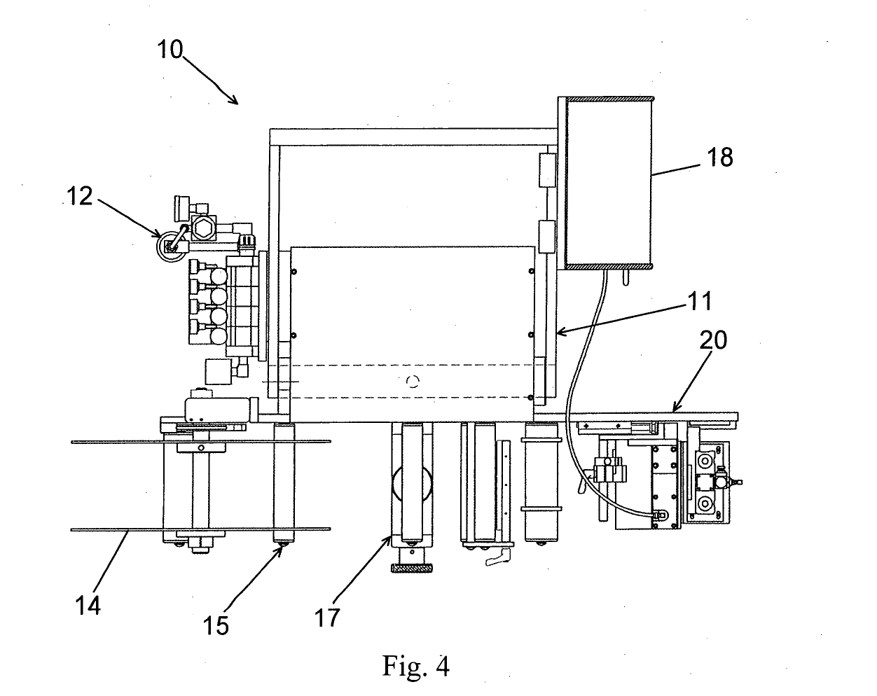

In FIGS. 3 and 4, a label applicator 10 is shown. Label applicator 10 generally includes the following components: a core unit 11; a valve unit 12; a supply spool 14, a tensioning spool array 15, a retrieval spool 16, a motor 17, a read/write (or reader) unit 18, and a snorkel unit 20. Generally, label applicator 10 without reader 18 is referred to as a label application assembly. Core unit 11 generally houses a controller, connectors to a power source and an air source, and data ports. The valve unit 12 generally provides pneumatic controls for certain label applicator operations, such as label application and rejection via snorkel unit 20. Supply spool 14 contains a label web 19, on which includes RFID labels 99 (not shown). Label web 19 travels through tensioning spool array 15, through snorkel unit 20, and returns to retrieval spool 16. Tensioning spool array 15 utilizes existing tensioning technology to ensure proper presentation and translation of label web 19. Motor 17 facilitates translation of label web 19 through label applicator 10. Read/write unit (reader) 18 communicates with RFID labels 99 via an antenna included within snorkel unit 20 for the purpose of reading from and writing to the RFID labels 99, verifying operational or active labels 99 and rejecting defective or improper labels 99, activating passive RFID labels 99, and storing data. The read/write unit 18 also processes data and/or commands. Read/write unit 18 will reject a RFID label 99 based on user-defined criteria, such as when: the read/write unit 18 fails to receive a response from the RFID label 99; the read/write unit 18 fails to receive any transmission from the RFID label 99; the RFID label 99 does not contain necessary user-defined information; or the read/write unit is unable to write to the RFID label 99. Although not necessary, read/write unit 18 may transmit RF waves through an antenna at different power levels during read and write cycles because the power required for optimal read cycle performance is different than that required for optimal write cycle performance (as discussed above). Finally, snorkel unit 20 carries out many operations, including communicating with RFID labels 99 via an antenna contained therein, dispersing RFID labels 99 from label web 19 for application to products, applying RFID labels 99 to products, and ejecting rejected RFID labels 99 by failing to disperse the label 99 for product application. Core unit 11, valve unit 12, supply spool 14, tensioning spool array 15, retrieval spool 16, and motor 17 utilize technology well-known in the respective art and comprise any commercially available product thereof. Further, the location of all above-mentioned components within label applicator 10 are not critical to the current invention, except that the components must be arranged so that the collective continues to function as a label applicator. FIGS. 3 and 4 depict one of many possible arrangements of the above-mentioned components.

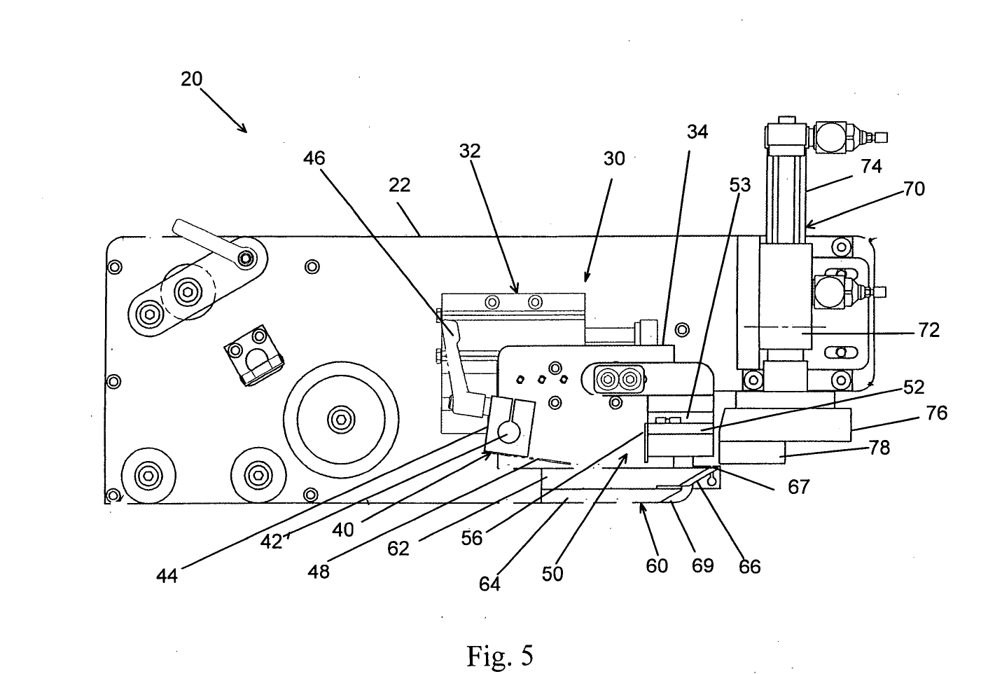

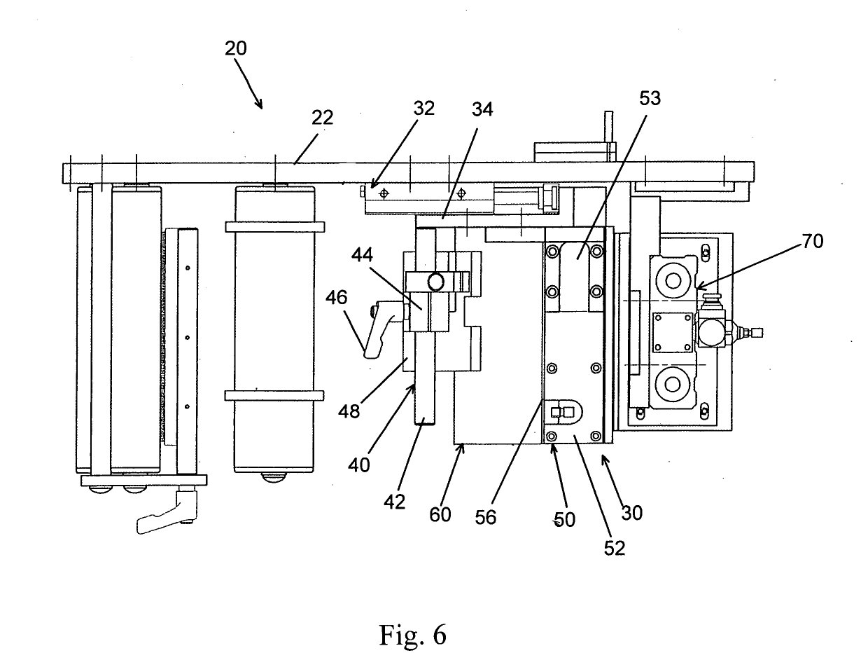

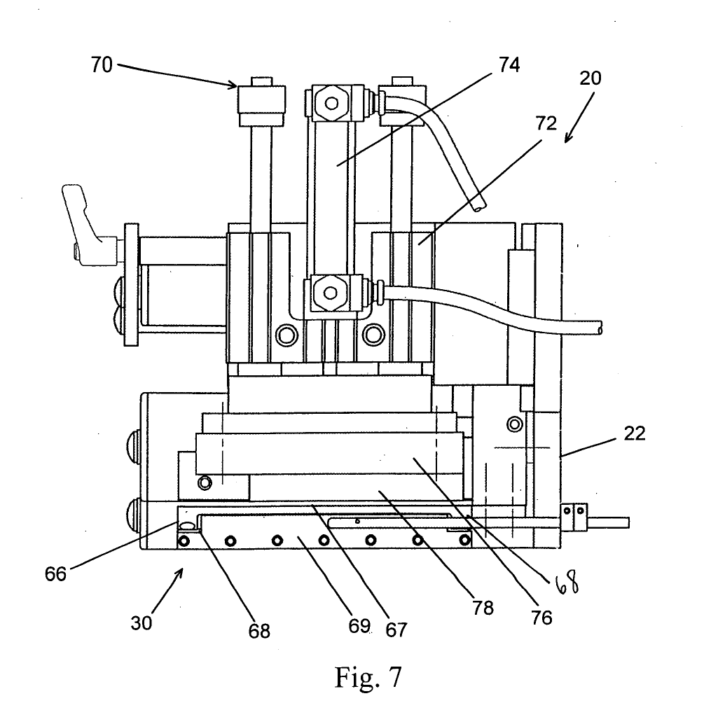

Referring to FIGS. 5 through 7, snorkel unit 20 includes a snorkel base 22, label processing unit 30, and a label applicator unit 70. Snorkel base 22 provides a surface to mount processing unit 30 and applicator unit 70. Generally, processing unit 30 provides an antenna unit 54 (not shown) that allows read/write unit 18 to communicate with RFID labels 99. After communicating with a RFID label 99, processing unit 30 then either extracts an operational label 99 from label web 19 and delivers it to applicator unit 70 or leaves a rejected label 99 on web 19 for return to retrieval spool 16 (also referred to as label ejection). After receiving an operational label 99, label applicator unit 70 temporarily retains the label 99 and subsequently transfers the label 99 to any desired product. While label applicator unit 70 is receiving and applying the operational label 99, a new RFID label 99 is drawn into position below antenna 54, verified operational or rejected, ejected if verified a rejected label 99, and, if desired, has data written thereto. Thus, the new RFID label 99 may be ready for delivery to applicator unit 70 immediately after applicator unit 70 applies the previously transferred label 99 to the product, depending on the user-defined operations to be performed on the new RFID label 99 by the read/write unit 18. By allowing the read/write unit 18 to operate on a label 99 while another is being applied to a product, the time extending between label applications is reduced.

The label processing unit 30 includes an ejector slide unit 32, a spring block unit 40, an antenna unit 50, and a peel unit 60. Ejector slide unit 32 provides a sliding mounting portion 34 that translates, thereby allowing a portion of the peel unit 60 to retract and eject a rejected label 99. Ejection allows a rejected label 99 to remain on label web 19 as it returns to retrieval spool 16, instead of transferring the label 99 from peel unit 60 to applicator unit 70, as with an operational label 99. It is contemplated that other orientations may exist that would require mounting portion 34 to translate in different directions to effect label ejection, including rotational translations. Ejector slide unit 32 mounts to the snorkel base 22.

Spring block unit 40 ensures proper label web 19 alignment and tension along top plate 62 and comprises a rod 42, a block 44 with securement means 46, and a spring plate 48. In the present embodiment, rod 42 attaches to mounting portion 34; however, it is contemplated that it could mount elsewhere, such as to top plate 62. Block 44 translates axially and radially about rod 42, allowing spring plate 48 to track the location of label web 19 and conform to the thickness of label web 19. Block 44 includes a securing means 46 for constraining block 44 to rod 42. In the present embodiment, the securing means 46 comprises a levered screw, although it is contemplated that any commercially available means may be used. Spring plate 48 attaches to block 44. By properly positioning and securing block 44, spring plate 48 applies pressure to label web 19 so to assist in constraining label web 19 as it approaches the antenna unit 50 and the peel unit 60. Spring plate 48 is made of acetal resin, such as DuPont's Delrin®, or any comparable commercially available material that does not interfere with RF waves. This provides more consistent read/write cycles between antenna 54 and the RFID labels 99, since the use of bare metal interferes with those cycles. It is contemplated that insulated metal may also be used. Rod 42, block 44, and securing means 46 may be formed of any commercially available material, whether metal or non-metal.

Antenna unit 50 may transmit or receive RF waves from a RFID label 99 and comprises an antenna housing 52, an antenna 54 (not shown), and an insulating plate 56. In the present embodiment, antenna unit 50 attaches to mounting portion 34; however, it is contemplated that antenna unit 50 may mount elsewhere, such as to top plate 62. Antenna housing 52 generally protects antenna 54 from physical damage by enclosing antenna 54 therein. In the present embodiment, antenna housing 52 is made of acetal resin, such as Delrin®, or any comparable material available commercially that does not interfere with RF signals sent to or from antenna 54. Because proper RF transmission to and from antenna 54 generally requires, based on the present embodiment, non-metallic material to be no closer than approximately one-half inch (½″) from antenna 54, a spacer made from acetal resin, or any other comparable material, may be required when attaching housing 52 to mounting portion 34. The location of metallic material in relation to antenna 54 may change as stronger or weaker RF waves are transmitted from antenna 54, thereby allowing metallic materials to be closer than or requiring metallic materials to be farther than one-half inch (½″) from antenna 54. Insulating plate 56 secures to the label web 19 upstream side (or the block 44 side) of antenna housing 52, to prevent approaching RFID labels 99 from being adversely affected by RF waves sent between antenna 54 and the intended RFID label 99 (generally closest to antenna 54). In the present embodiment, insulating plate 56 is made of stainless steel; however, it is contemplated that any other reflective material may be used. Antenna 54 comprises any commercially available RF antenna, such as those supplied by SAMSys Technologies Inc.

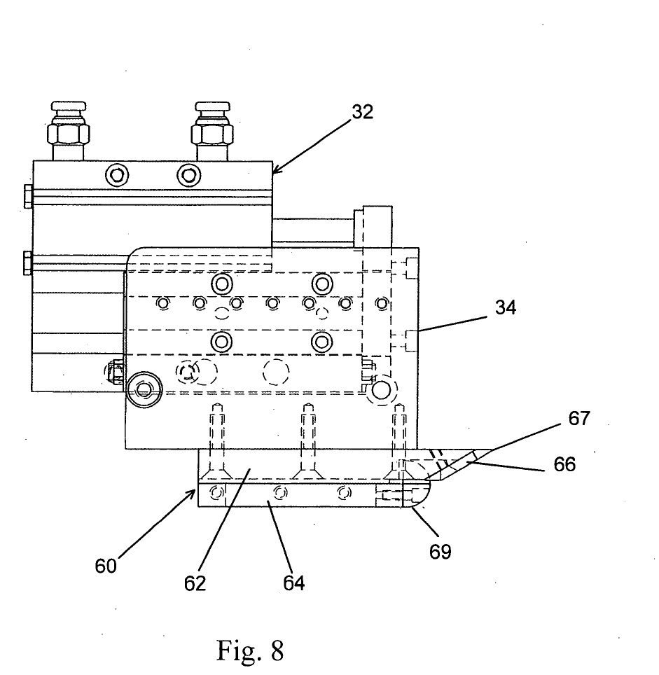

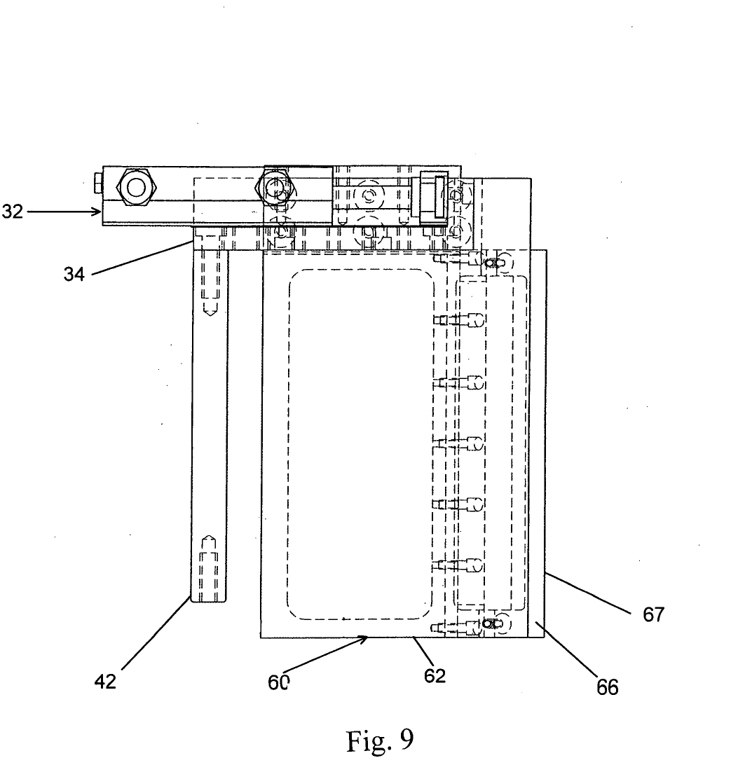

Referring to FIGS. 8-9, peel unit 60, generally, initiates the physical portion of the label application and ejection processes and comprises top plate 62, bottom plate 64, peel plate 66, peel edge 67, and return edge 69. If read/write unit 18 determines a label 99 operational, the label 99 is separated from label web 19 at peel edge 67 and transferred to application unit 70 for product application. Tensile forces arising between the label 99 and the label web backing cause the label 99 to separate from label web 19 at peel edge 67, due to the high return angle experienced by label web 19 as it navigates around peel edge 67 toward retrieval spool 16. If read/write unit 18 determines a label 99 is defective or otherwise rejected, the label 99 remains on label web 19 by retracting top plate 62. This provides a more gradual path around peel edge 67, thereby avoiding the separation forces associated with a high return angle. In the present embodiment, top plate 62 attaches to mounting portion 34 below spring plate 48 and antenna unit 50; however it is contemplated top plate 62 may mount elsewhere, such as to antenna unit 50, and above spring plate 48 and antenna unit 50. Further, top plate 62 is made of acetal resin, such as Delrin®, or any comparable material available commercially that does not interfere with RF signals. In the present embodiment, top plate 62 thickness is approximately one-half inch (½″) to prevent RF signal interference resulting from signal reflections, as seen at higher thicknesses; however, it is contemplated that different thickness may be required based upon the material used and/or the existing RF system (having different RF wave frequencies and amplitudes).

Peel plate 66 attaches to at least a portion of the top plate 62 and is located along a top edge and adjacent side thereof, where the downstream portion of the RFID web travels after passing antenna unit 50 (typically located nearest the label applicator unit 70). Any commercially available means of attachment may be used, including fasteners and clips. The purpose of peel plate 66 is to provide a replaceable wear part, since the label web 19 travels over and around the uppermost portion thereof, of which at least includes the peel edge 67. In the present embodiment, the side portion of top plate 62 adjacent peel plate 66 is chamfered or angled (linearly or arced) inward from the uppermost portion of the top plate 62; although it is contemplated that peel plate 66 may comprise a triangular-like cross-section in an effort to duplicate the present profile formed by top plate 62 with peel plate 66. The purpose of the angled side is to provide the a high angle of return for label web 19 (generally more than ninety degrees (90°)) about peel edge 67 for separating labels 99 from label web 19. Peel plate 66 generally has a trapezoidal cross-sectional shape, thereby facilitating its mounting to top plate 62 while maintaining an uppermost surface that is substantially co-planar with the uppermost surface of top plate 62. Peel edge 66 may include mounting flanges 68, which extend further along the mounting side of top plate 62. The inclusion of flanges 68 facilitates the reduction of material in the remaining portions of peel plate 66, thereby minimizing RF signal reflection (interference). In the present embodiment, peel plate 66 is made from stainless steel for its wear properties; however, it is contemplated that peel plate 66 may be made from any other comparable metal or non-metal material. It is also contemplated that the cross-sectional shape of peel plate 66 may be non-trapezoidal and the peel plate 66 may mount to the uppermost surface of top plate 62.

Bottom plate 64 attaches to snorkel base 22 below and in close proximity to top plate 62, for the purpose of providing support thereto. It is contemplated that bottom plate 64 may mount elsewhere, such as to the stationary portion of slide unit 32. In the present embodiment, bottom plate 64 is made of aluminum; however, it is contemplated that different materials may be used, such as steel or acetal resin. The aluminum bottom plate 64 comprises a frame having an open center, for the purpose of minimizing RF reflection, and is approximately three-eighths of an inch (⅜″) thick; however, different designs and thicknesses may be required or allowed based upon the material used and/or the existing RF system (having different RF wave frequencies and amplitudes). A return edge 69 attaches to a side of bottom plate 64 substantially adjacent to peel edge 67, so to contact label web 19 after translating from peel edge 67. Return edge 69 is rounded and made of acetal resin, such as Delrin®, or any other comparable material available commercially. This minimizes damage to label web 19 by providing a low-friction surface for improved translation as web 19 exits peel edge 67, around bottom plate 64 and toward retrieval spool 16.

Once a label 99 is separated from the label backing at the peel edge 67, it travels to the applicator unit 70 (referring again to FIGS. 5-7). In the present embodiment, applicator unit 70 utilizes a tamp blow application method; however, it is contemplated that merge or air-blow application methods may be used. The tamp applicator unit 70 includes tamp slide mechanism 72, actuator (or cylinder) 74, manifold 76, and label pad 78. Tamp slide mechanism 72 provides a unit that translates in response to actuator 74, and to which manifold 76 mounts. Manifold 76 provides a vacuum that allows attached label pad 78 to grasp a label 99 as it separates from the label web backing at peel edge 67. While label pad 78 grasps the label 99, actuator 74 directs label pad 78 via tamp slide mechanism 72 toward the to-be-labeled product. Applicator unit 70 then applies the label 99 retained by label pad 78 by terminating the vacuum and then blowing the label 99 against the product. In the present embodiment, a product sensor initiates actuator 74 and/or the termination of the vacuum and creation of the blow operation. In use, the product sensor may initiate actuator 74, terminate vacuum, and blow sequentially as stated above. Also, actuator 74 may extend to a predefined length without receiving any signal from the product sensor, which then only requires product sensor to initiate termination of the vacuum and generation of the blow operation. It is contemplated that any commercially available applicator unit 70 may be used, except that label pad 78 is to be made of aluminum, or any other comparable metal or metal composite that prevents RF waves from adversely affecting the label 99 grasped by label pad 78. It is further contemplated that applicator unit 70 may include either actuator 74 or the blow operation, without the other.

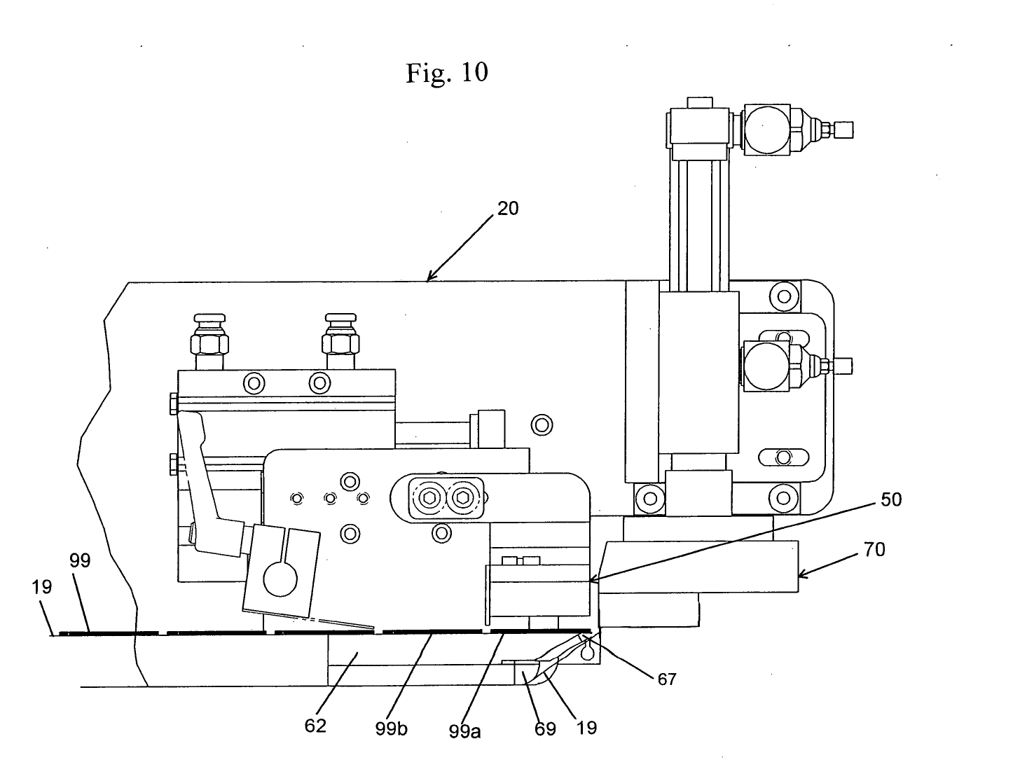

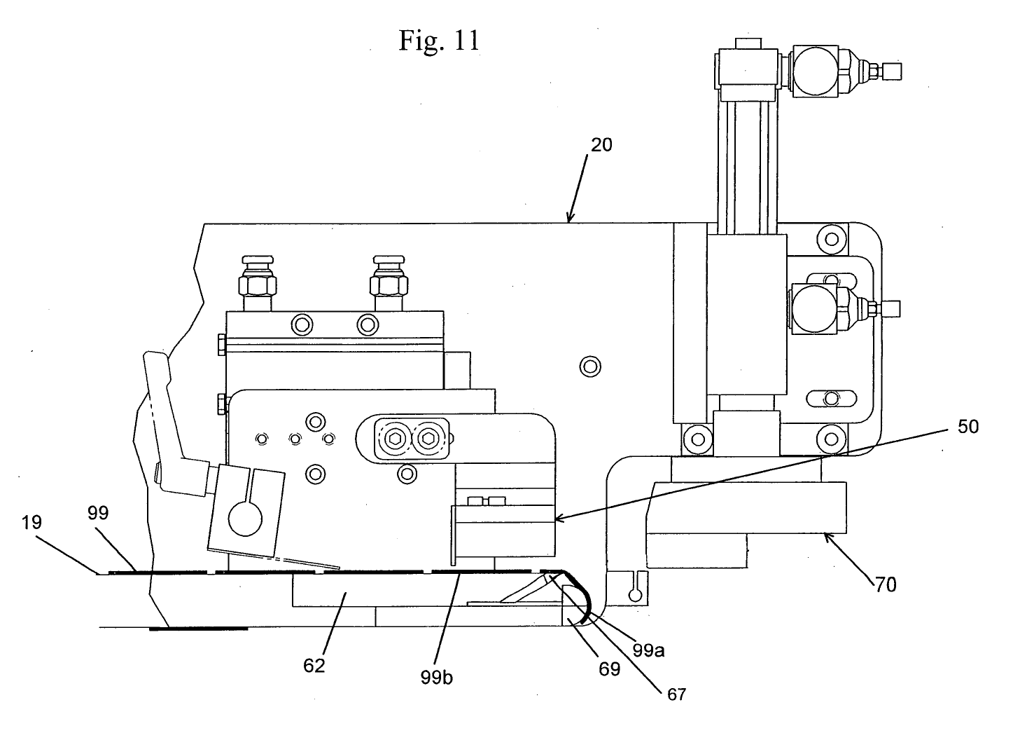

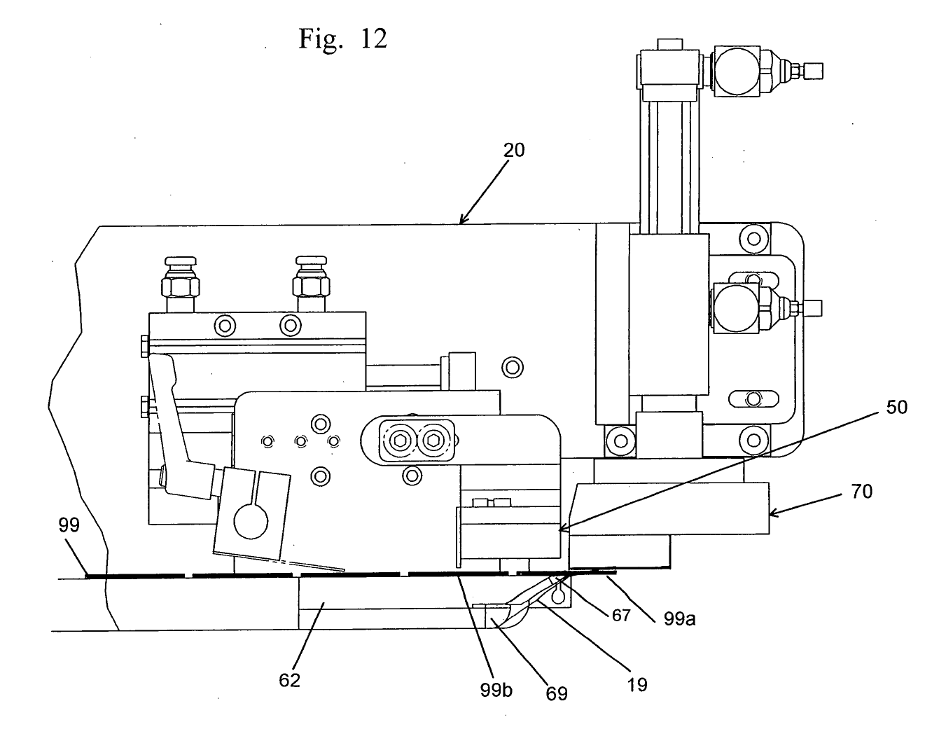

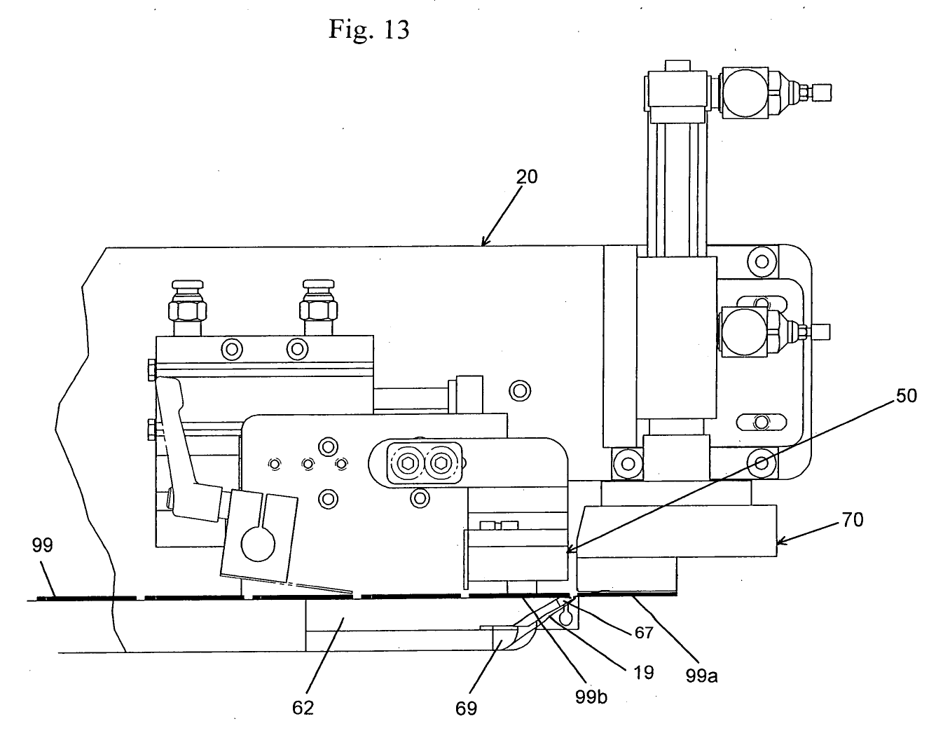

FIGS. 10-13 show the operation of label applicator 10, and more specifically the progression of label web 19 and RFID labels 99 through the snorkel unit 20. In operation, and after entering snorkel unit 20, label web 19 translates upon the top plate 62 of peel unit 60 to place a label 99a below antenna unit 50 (FIG. 10). At this time, any read/write operations are performed on label 99a. After all read/write operations are complete, label web 19 continues to translate upon top plate 62 toward peel edge 67. As a label 99 approaches peel edge 67, the read/write unit 18 has already determined whether label 99a is to be applied to a product or whether label 99a is to be ejected. If label 99a is to be ejected (FIG. 11), top plate 62 slides away from the applicator unit 70 (in the label web 19 upstream direction), thereby allowing label web 19 to continue to travel toward applicator unit 70 at a decreasing angle until reaching return edge 69, whereupon the label web 19 travels around toward retreival spool 16. This course of travel reduces separation stresses (primarily tensile) within the adhesive between label 99a and label web 19, thereby allowing label 99a to remain on label web 19 as it returns to retrieval spool 16. As the ejected label is removed from top plate 62, another label 99b is being placed underneath antenna unit 50 to begin the same process. If label 99a is operational (FIGS. 12-13), label web 19 proceeds over and about peel edge 67, leaving peel edge 67 in a downward direction away from applicator unit 70. This provides separation stresses (primarily tensile) within the adhesive between label 99a and label web 19, sufficient to separate label 99a from label web 19. Applicator unit 70 then obtains label 99a for its application to a product. As label 99a is being transferred to applicator unit 70, label 99b is being placed into position under antenna unit 50 to begin the same process. While applicator unit 70 is applying label 99a to a product, read/write operations may begin to reduce any delay in translating label 99b after application of label 99a. Note, the read/write operations upon a label 99 may begin before a label 99 is completely under antenna unit 50 (or as label 99 translates towards antenna unit 50) and may continue as label 99 translates away from antenna unit 50.

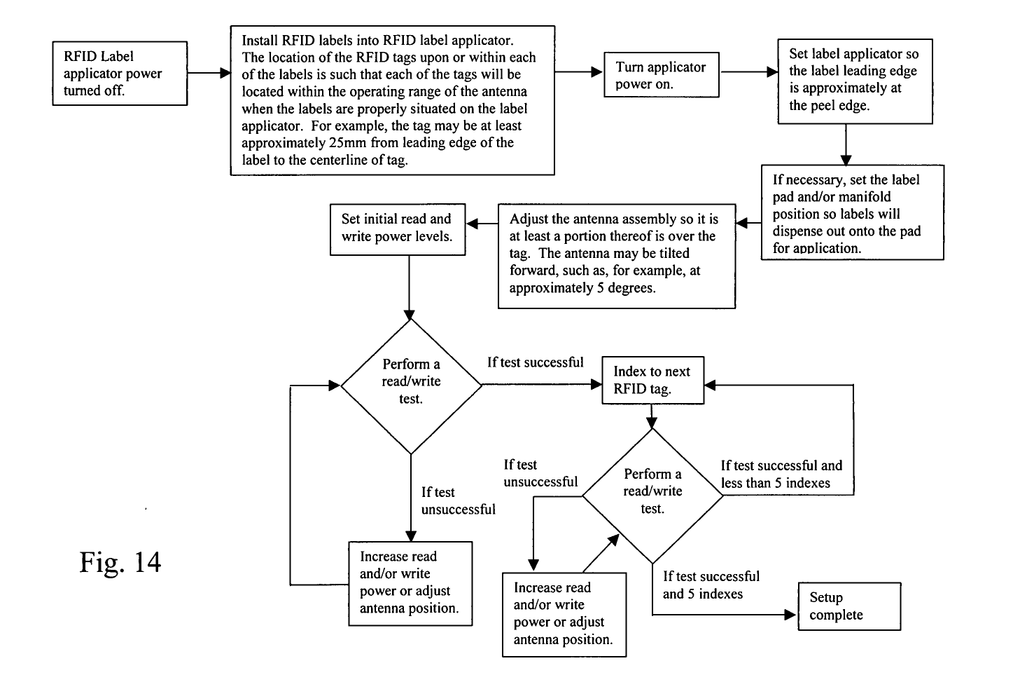

FIG. 14 shows a flow chart outlining a sample procedure for determining acceptable read and write power levels for label applicator 10, detailed above. This procedure exemplifies one of many acceptable procedures for determining acceptable read and write power levels for label applicator 10, or any other label applicator. This sample procedure incorporates the procedure detailed in paragraph 29 above and includes, for example, the sample system 1 detailed in paragraph 30.

Although the present invention has been described above in detail, the same is by way of illustration and example only and is not to be taken as a limitation on the present invention.

I claim the following:

1. An RFID system comprising:
an RFID read unit, the read unit capable of performing read operations;
an RFID write unit, the write unit capable of performing write operations;
wherein the read unit performs read operations at a first power level and the write unit performs write operations at a second power level, the first power level being different than the second power level.

2. The RFID system of claim 1, wherein the first power level is less than the second power level.

3. The RFID system of claim 1, wherein the RFID read unit and the RFID write unit are formed as a single read/write unit.

4. The RFID system of claim 1, further comprising at least one controller, the at least one controller being operably attached to at least one of the read unit and the write units;
wherein the at least one controller directs the read unit to perform read operations at the first power level and directs the write unit to perform write operations at the second power level.

5. The RFID system of claim 4, wherein the controller is an integrated circuit or microprocessor.

6. The RFID system of claim 4, wherein the controller includes an operating system.

7. The RFID system of claim 1, wherein the reader operates at ultra high frequencies.

8. The RFID system of claim 1, further comprising at least one antenna, the antenna being operably attached to at least one of the read unit and the write unit for transmitting or receiving RF signals for at least one of the reader or write unit.

9. The RFID system of claim 8, wherein the antenna is a dipole or loop antenna.

10. The RFID system of claim 8, wherein the antenna is located approximately between 0.02 and 1.5 inches from a target RFID tag.

11. The RFID system of claim 1, further comprising a means for applying an RFID label to a target object, the label including an RFID tag.

12. The RFID system of claim 1, further comprising a label applicator assembly.

13. An RFID system comprising:
a means for reading from an RFID tag; and
a means for writing to an RFID tag;
wherein the means for reading performs read operations at a first power level and the means for writing performs write operations at a second power level, the first power level being different than the second power level.

14. A method of reading and/or writing to an RFID tag comprising the steps of:
providing a first RF transmission power level for performing a read operation;
providing a second RF transmission power level for performing a write operation, and
performing the read operation at the first power level or the write operation at the second power level, wherein the first power level is different from the second power level.

15. The method of reading and/or writing of claim 14, wherein the step of performing the read operation at the first power level or the write operation at the second power level comprises performing the read and the write operation.

16. The method of reading and/or writing of claim 20, wherein the read operation occurs after the write operation.

17. A method of controlling an RFID reader comprising the steps of:
providing a controller configured to direct a read unit to perform a read operation at a first power level; and
providing a controller configured to direct a write unit to perform a write operation at a second power level, wherein the second power level is different than the second power level.

18. The method of controlling of claim 17, further comprising the step of directing the read unit to perform the read operation at the first power level.

19. The method of controlling of claim 17, further comprising the step of directing the write unit to perform the write operation at the second power level.

20. The method of controlling of claim 17, further comprising the step of determining acceptable read and write power levels.
